(19) United States
(12) Patent Application Publication
(10) Pub. No.: US 2025/0368104 A1
(43) Pub. Date: Dec. 4, 2025

(54) HEATER CONTROL METHOD FOR VEHICULAR SEAT

(71) Applicant: TOYOTA BOSHOKU KABUSHIKI KAISHA, Aichi-ken (JP)

(72) Inventor: Kenichi TSUKAMOTO, Okazaki-shi (JP)

(73) Assignee: TOYOTA BOSHOKU KABUSHIKI KAISHA, Aichi-ken (JP)

(21) Appl. No.: 19/219,184

(22) Filed: May 27, 2025

(30) Foreign Application Priority Data
Jun. 3, 2024 (JP) 2024-089857

(51) Int. Cl. B60N 2/56

(52) U.S. Cl. CPC B60N 2/5678; B60N 2210/30

(57) ABSTRACT

There are provided a heater control method for a vehicular seat, and a heater control system thereof. A warming period by a heater is divided into a first time period including start of warming and a second time period following the first time period. A first heater region is controlled to be continuously set in a warming state between the first time period and the second time period. A second heater region is controlled to be set in the warming state in the first time period and to be set, during the second time period, in a low-temperature warming state having a lower temperature than the warming state in the first time period or in a non-warming state. The first heater region and the second heater region are provided in at least one position of seating surfaces of a seat cushion and a seat back of the vehicular seat.

### CROSS-REFERENCE TO RELATED APPLICATIONS

This application is based on and claims priority under 35 USC 119 from Japanese Patent Application No. 2024-089857 filed on Jun. 3, 2024, the contents of which are incorporated herein by reference.

### TECHNICAL FIELD

The present disclosure relates to a heater control method for a vehicular seat including a plurality of heater regions.

### BACKGROUND ART

This type of vehicular seat includes a seat cushion serving as a seat portion and a seat back serving as a backrest. By providing heaters (heating elements) on a seating surface of the seat cushion and a seating surface of the seat back, a seated occupant can be warmed. In the field of the vehicular seat described above, there is a demand for heater control that contributes to power saving while ensuring warming property for an occupant. As this type of technique, JP2009-269480A, JP5708189B2, and JP5625973B2 describe a technique in which a seating surface is divided into a plurality of portions, and from the viewpoint of power saving, a portion to be warmed or a temperature is changed over time.

For example, in JP2009-269480A, a seating surface of a seat cushion is bisected into a front portion and a rear portion. Three heating elements are provided at the rear portion of the seat cushion in a manner of being aligned in a seat width direction, so that the heating elements are disposed on the right side, the center, and the left side. Also in the front portion of the seat cushion, three heating elements are aligned in the seat width direction, so that the heating elements are disposed on the right side, the center, and the left side.

In the technique described in JP2009-269480A, in a time period of initial warming, electricity is supplied only to the heating element at the center of the rear portion of the seat cushion, and electricity is supplied only to the left and right heating elements at the front portion of the seat cushion (first electricity supply pattern). In a subsequent time period, electricity is supplied only to the left and right heating elements at the rear portion of the seat cushion, and electricity is supplied only to the central heating element at the front portion of the seat cushion (second electricity supply pattern). In this way, in the technique described above, by repeating the first electricity supply pattern and the second electricity supply pattern to warm a specific portion for a predetermined time, the power consumption of the seat can be reduced. In the technique described above, it is also possible to supply electricity to all the heating elements in the time period of the initial warming and then warm in the first electricity supply pattern.

However, in the technique of JP2009-269480A described above, when the first electricity supply pattern and the second electricity supply pattern are repeated from the viewpoint of power saving, there is a problem that a target portion of an occupant cannot be continuously warmed. Further, even if only the center of the seat is heated, it is difficult to warm the target portion (buttocks or waist) of the occupant at an appropriate temperature due to the heat of the center propagating to the left and right or the like. Further, when electricity is supplied only to a specific heating element in the time period of initial warming, the temperature rise of the entire seating surface becomes gradual. Therefore, some occupants may feel that the temperature is low and lukewarm, and it takes time to perceive sufficient warming. Also in the technique of JP5708189B2, and JP5625973B2, since the portion to be warmed or the temperature changes over time, there is a possibility that the target portion of the occupant cannot be continuously warmed at an appropriate temperature, and the control tends to be complicated. Therefore, in this type of technical field, there is a demand for more reliably achieving both warming property and power saving property.

### SUMMARY OF INVENTION

According to a first aspect of the present disclosure, there is provided a heater control method for a vehicular seat, in which a seating surface of the vehicular seat is provided with a first heater region and a second heater region in a divided state as a region including a heater. A warming period by the heater is divided into a first time period including start of warming and a second time period following the first time period. The first heater region is controlled to be continuously set in a warming state between the first time period and the second time period. The second heater region is controlled to be set in the warming state in the first time period and to be set, during the second time period, in a low-temperature warming state having a lower temperature than the warming state in the first time period or in a non-warming state. The first heater region and the second heater region are provided in at least one position of the following positions 1 and 2. In the position 1, a seating surface of a seat cushion to be a seat portion includes a lower top plate main portion extending in a front-rear direction at a center in a seat width direction, the first heater region is provided in a rear portion of the lower top plate main portion configured to support occupant's buttocks, and the second heater region is provided in a front portion of the lower top plate main portion with respect to the first heater region. In the position 2, a seating surface of a seat back to be a backrest includes an upper top plate main portion extending in an up-down direction at the center in the seat width direction, the first heater region is provided in a lower portion of the upper top plate main portion configured to support an occupant's waist, and the second heater region is provided in an upper portion of the upper top plate main portion with respect to the first heater region.

In the configuration described above, both the first heater region and the second heater region are controlled to be set in the warming state in the first time period. Accordingly, the temperature of the seating surface rises quickly, which contributes to ensuring the temperature rising property. Further, the first heater region is controlled to be set in the warming state in the second time period. The first heater region is provided at the rear portion of the seat cushion and the lower portion of the seat back. Accordingly, the first heater region can continuously warm the target portions of the occupant (occupant's buttocks and an occupant's waist) at a suitable temperature as much as possible. During the second time period, the second heater region is controlled to be set in the low-temperature warming state or the non-warming state, which contributes to securing power saving.

According to a second aspect of the present disclosure, in the heater control method for the vehicular seat of the first aspect, a third heater region including a heater is provided in a position of a seating surface different from the first heater region and the second heater region. The third heater region is controlled to be set in the warming state in the first time period and to be set, during the second time period, in the low-temperature warming state or the non-warming state in synchronization with or independently of the second heater region. In the present disclosure, the occupant can be warmed over a wider range by the function of the first heater region, the second heater region, and the third heater region. By synchronizing the second heater region and the third heater region, control is facilitated, and by controlling both the second heater region and the third heater region independently, the occupant can be finely warmed.

According to a third aspect of the present disclosure, in the heater control method for the vehicular seat of the second aspect, the first heater region, the second heater region, and the third heater region are provided in at least one position of the following positions 1 and 2. In the position 1, the first heater region is provided in the rear portion of the lower top plate main portion, the second heater region is provided in the front portion of the lower top plate main portion with respect to the first heater region, and the third heater region is provided in a side portion in the seat width direction of the lower top plate main portion. In the position 2, the first heater region is provided in the lower portion of the upper top plate main portion, the second heater region is provided in the upper portion of the upper top plate main portion with respect to the first heater region, and the third heater region is provided in a side portion in the seat width direction of the upper top plate main portion. In the present disclosure, the third heater region functions to warm the top plate side portions of the seat cushion or the seat back, thereby warming the occupant from sides thereof.

According to the first aspect of the present disclosure, both the warming property and the power saving property can be more reliably achieved. According to the second aspect of the present disclosure, both the warming property and the power saving property can be more appropriately achieved. According to the third aspect of the present disclosure, the warming property can be more appropriately secured.

### BRIEF DESCRIPTION OF DRAWINGS

FIG. 1 is a schematic perspective view of a vehicular seat;

FIG. 2 is a schematic perspective side view of the vehicular seat;

FIG. 3 is a graph illustrating a temperature change over time in heater regions;

FIG. 4 is a schematic perspective view of the vehicular seat illustrating the heater regions in a warming state;

FIG. 5 is a schematic view of a human model for a human body thermal model;

FIG. 6 is a graph illustrating a temperature change of a seating surface over time;

FIG. 7 is a graph illustrating an integrated heat balance change over time output from the human body thermal model; and

FIG. 8 is a schematic perspective view of the vehicular seat illustrating position of third heater regions.

### DESCRIPTION OF EMBODIMENTS

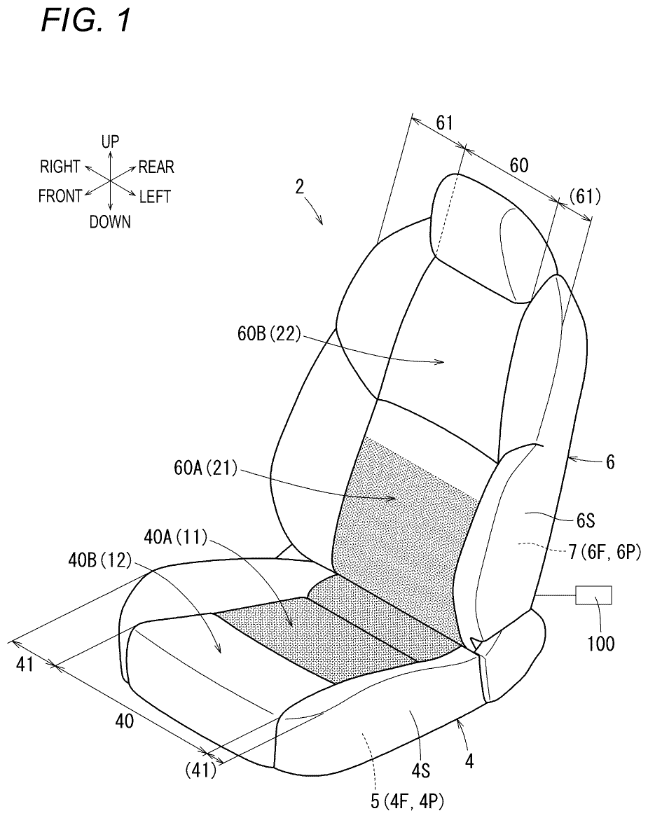

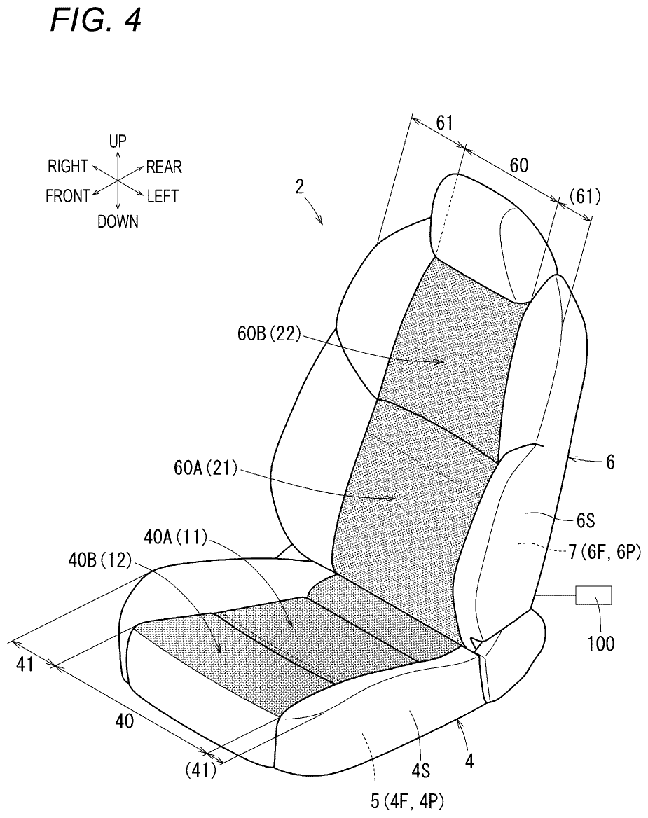

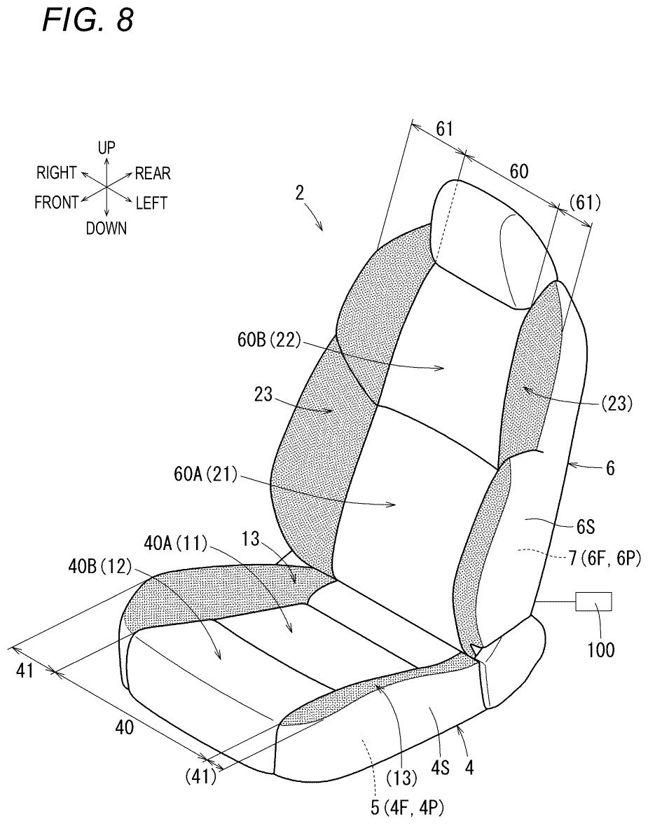

Hereinafter, an embodiment of the present disclosure will be described with reference to FIGS. 1 to 8. In each drawing, arrows indicating a front-rear direction, an up-down direction, and a left-right direction (seat width direction) of a vehicular seat are appropriately illustrated. In FIG. 1, dots are applied only to a rear portion of a seat cushion and a lower portion of a seat back in order to facilitate division of heater regions. For the same reason, in FIG. 8, only top plate side portions of the seat cushion and the seat back are dotted. In FIG. 4, the heater regions in a warming state are illustrated with dots.

### Outline of Vehicular Seat

First, an outline of the vehicular seat 2 illustrated in FIG. 1 will be described. In the vehicular seat 2, a lower portion of a seat back 6 is connected to a rear portion of a seat cushion 4 via a recliner (not illustrated). Here, the seat cushion 4 is a member serving as a seat portion, and is formed in a rectangular shape elongated in a front-rear direction in a top view.

The seat back 6 is a member serving as a backrest for an occupant, and is formed in a rectangular shape elongated in an up-down direction in a front view. In the seat cushion 4, a lower internal member 5 such as a metal cushion frame 4F forming a seat framework and a foamed resin cushion pad 4P elastically supporting an occupant is covered with a cushion cover 4S forming a seat outer surface. Similarly, in the seat back 6, an upper internal member 7 such as a back frame 6F and a back pad 6P is covered with a back cover 6S.

At a center in a seat width direction of an upper surface of the seat cushion 4 illustrated in FIG. 1, a lower top plate main portion 40 on which an occupant can sit is formed in a manner of extending in the front-rear direction of the seat. In the seat cushion 4, (right and left) side portions in the seat width direction of the lower top plate main portion 40 are raised to an upper side serving as a seating side. Lower top plate side portions 41 of the seat cushion 4 are formed in a manner of extending in the front-rear direction of the seat by inner side portions of the portions raised to the seating side (in FIG. 1, a reference numeral corresponding to the right lower top plate side portion is given, and a reference numeral corresponding to the left lower top plate side portion is given in parentheses). In the configuration described above, a seating surface of the seat cushion 4 is formed by the lower top plate main portion 40 and the left and right lower top plate side portions 41.

At a center in the seat width direction of a front surface of the seat back 6 illustrated in FIG. 1, an upper top plate main portion 60 on which an occupant can sit is formed in a manner of extending in the up-down direction of the seat. In the seat back 6, (right and left) side portions in the seat width direction of the upper top plate main portion 60 are raised to a front side serving as a seating side. Upper top plate side portions 61 of the seat back 6 are formed in a manner of extending in the up-down direction of the seat by inner side portions of the portions raised to the seating side (in FIG. 1, a reference numeral corresponding to the right upper top plate side portion is given, and a reference numeral corresponding to the left upper top plate side portion is given in parentheses). In the configuration described above, a seating surface of the seat back 6 is formed by the upper top plate main portion 60 and the left and right upper top plate side portions 61.

### Heater Control Method for Vehicular Seat

In the vehicular seat 2 illustrated in FIG. 1, a plurality of heater regions can be provided in at least one of the seat cushion 4 or the seat back 6. That is, in the seat cushion 4, a plurality of heater regions (a lower first heater region 11, a lower second heater region 12, and the like described later) can be provided in a divided state on the seating surface. Also in the seat back 6, a plurality of heater regions (an upper first heater region 21, an upper second heater region 22, and the like described later) can be provided in a divided state on the seating surface.

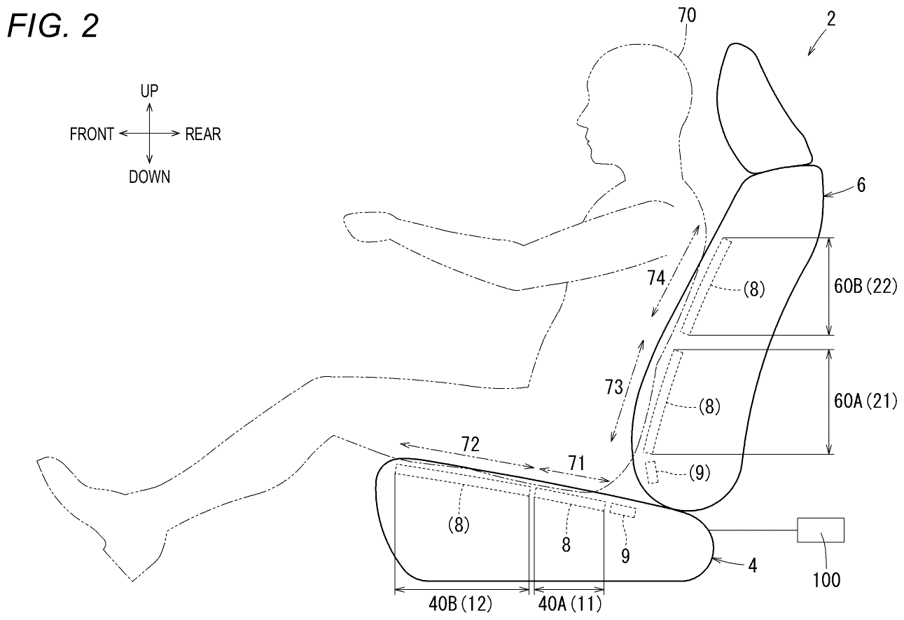

With reference to FIG. 2, each of the heater regions described above includes a heater 8 controlled by a controller 100 (in FIG. 2, for convenience, reference numerals corresponding to some heaters are given and reference numerals corresponding to the other heaters are given in parentheses). The heater 8 is a mat-like or planar member including a heating element, and can be disposed, for example, between the cushion cover and the cushion pad (between the back cover and the back pad). By supplying electricity to each heater 8 under the control of the controller 100, each heater region is brought into a warming state. At this time, by controlling the amount of electricity supplied to the heater 8, each heater region can be brought into a low-temperature warming state in which a temperature is lower than that of the warming state. By stopping the supply of electricity to the heater 8 under the control of the controller 100, each heater region is brought into a non-warming state.

In the configuration described above, it is desired to achieve both warming property and power saving property by appropriately controlling each heater region of the vehicular seat 2 illustrated in FIGS. 1 and 2. Therefore, in the present embodiment, both the warming property and the power saving property of the seat are more reliably achieved by the configuration and control described later. Hereinafter, the heater control method for the vehicular seat 2 will be described in the order of a heater configuration and a control method of the seat cushion 4 and a heater configuration and a control method of the seat back 6.

### Heater Configuration of Seat Cushion

The lower top plate main portion 40 of the seat cushion 4 illustrated in FIGS. 1 and 2 is divided into a rear portion 40A and a front portion 40B. The rear portion 40A of the lower top plate main portion 40 is a portion that supports occupant's buttocks 71 (see a dotted portion in FIG. 1). The front portion 40B of the lower top plate main portion 40 is a portion that supports occupant's thighs 72 and the like by being disposed forward relative to the rear portion 40A. With reference to FIG. 2, the occupant's buttocks 71 are desired to be continuously warmed because the occupant's buttocks 71 have a relatively large amount of fat and are less sensitive to heat. Meanwhile, the occupant's thighs 72 are more sensitive to temperature than the buttocks due to concentration of sensory nerves and the like, and have a smaller thermal capacity due to the smaller amount of subcutaneous fat. Therefore, the occupant's thighs 72 are less required to be continuously warmed as compared with the occupant's buttocks 71, and are sensitive to temperature and changes in temperature.

### First Heater Region and Second Heater Region

With reference to FIGS. 1 and 2, in the seat cushion 4, the seating surface is divided into heater regions as follows in consideration of thermal sensation characteristics of an occupant 70. That is, in the seat cushion 4, the lower first heater region 11 is provided in the rear portion 40A of the lower top plate main portion 40, and the occupant's buttocks 71 can be warmed by the lower first heater region 11 (see the dotted portion in FIG. 1). A formation range of the lower first heater region 11 can be set around a portion to which a seating pressure is most applied in the rear portion 40A of the seat cushion 4 supporting the occupant's buttocks 71. For example, in the present embodiment, the lower first heater region 11 is provided in substantially the entire region of the rear portion 40A of the lower top plate main portion 40 so as to more reliably cover the occupant's buttocks 71. In the seat cushion 4, the lower second heater region 12 is provided in the front portion 40B of the lower top plate main portion 40, and the occupant's thighs 72 can be warmed by the lower second heater region 12. For example, in the present embodiment, the lower second heater region 12 is provided in substantially the entire region of the front portion 40B of the lower top plate main portion 40 so as to more reliably cover the occupant's thighs 72. In the seat cushion 4, as will be described later, each heater region can be individually controlled by the controller 100, that is, the heater control can be divided into at least two systems for control.

### Power Density

With reference to FIGS. 1 and 2, in the seat cushion 4, the power density of the heater 8 in the lower first heater region 11 and the lower second heater region 12 can be set in consideration of heating performance and the like (the power density of a third heater region will be described later). The power density is a power load per unit area in a heat generating portion of the heater 8, and the heater 8 having a predetermined power density can be disposed in each heater region. Therefore, in the seat cushion 4, the power density of the heater 8 disposed in the lower first heater region 11 is set in a range of 200 W/m² to 600 W/m², preferably in a range of 250 W/m² to 450 W/m². This makes it easy to ensure the temperature rising property of the lower first heater region 11, and is suitable for continuous warming at an appropriate temperature, which will be described later. In addition, the power density of the heater 8 disposed in the lower second heater region 12 is set to be within the same range as that of the lower first heater region 11, which makes it easy to ensure the temperature rising property of the lower second heater region 12, and contributes to securing the power saving property of the seat. When the power density in each heater region deviates from the above range, there is a risk that a desired heating performance target of the seat cushion 4 will be exceeded or fallen short.

In the vehicular seat 2 illustrated in FIG. 2, temperature sensors 9 are provided at predetermined positions (in FIG. 2, for convenience, only two temperature sensors are illustrated, and a reference numeral corresponding to one temperature sensor is given, and a reference numeral corresponding to the other temperature sensor is given in parentheses). For example, in the seat cushion 4, one or more temperature sensors 9 are provided in each of the rear portion 40A and the front portion 40B of the lower top plate main portion 40 and the lower top plate side portions 41. When at least one of the heater regions is in the warming state, temperature information at each position of the seating surface is input to the controller 100.

### Heater Control of Seat Cushion

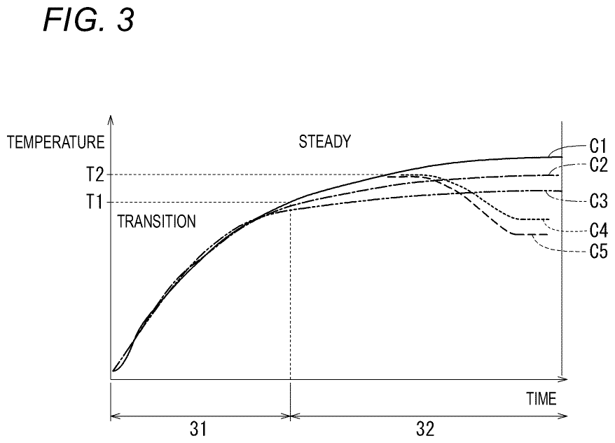

In the seat cushion 4 illustrated in FIGS. 1 and 2, each of the heater regions described above can be brought into the warming state for a predetermined period. At this time, in the heater control of the seat cushion 4, first, as illustrated in FIG. 3, a warming period in each heater region is divided into a first time period 31 and a second time period 32 following the first time period 31 based on the temperature of the seating surface. The first time period 31 includes the start of warming, that is, a rising period immediately after electricity is supplied to the heater, and is a time period during which the temperature of the seating surface rises over time. As compared with the first time period 31, the second time period 32 is a time period in which the temperature of the seating surface is higher and the temperature change (temperature fluctuation or the like) is relatively small. In the second time period 32, the temperature of the seating surface gradually approaches a setting temperature set in advance (see a first temperature change curve C1 in FIG. 3). A plurality of setting temperatures may be set as the setting temperature. For example, when the setting temperature described above (see the first temperature change curve C1 in FIG. 3) is set as a highest temperature setting, a second temperature setting (see a second temperature change curve C2 in FIG. 3) of a lower temperature or a third temperature setting (see a third temperature change curve C3 in FIG. 3) of a lowest temperature can be set. Accordingly, the occupant can select one setting temperature from the plurality of setting temperatures.

With reference to FIG. 3, a timing (transition temperature T1) of transition from first time period 31 to second time period 32 is not particularly limited. For example, the transition temperature T1 can be set based on a range of temperature change (fluctuation) on each seating surface. In this case, the transition from the first time period 31 to the second time period 32 can be made at a timing when the temperature change range of the seating surface becomes ±1° C., that is, at a timing when a steady state is reached (each numerical value does not limit the present disclosure).

### Heater Control During First Time Period

With reference to FIGS. 3 and 4, in the heater control of the seat cushion 4, both the lower first heater region 11 and the lower second heater region 12 are controlled to be set in the warming state in the first time period 31 (in FIG. 4, the heater regions in the warming state are dotted). In this case, the temperatures of both the lower first heater region 11 and the lower second heater region 12 rise over time as indicated by the first temperature change curve C1 illustrated in FIG. 3. In this way, both the lower first heater region 11 and the lower second heater region 12 are brought into the warming state in the first time period 31, thereby warming substantially the entire region of the lower top plate main portion 40, and contributing to ensuring the temperature rising property. With reference to FIG. 2, since both the occupant's buttocks 71 and the occupant's thighs 72 are warmed by the lower first heater region 11 and the lower second heater region 12, the occupant 70 seated in the seat can perceive warmth early.

### Heater Control During Second Time Period

With reference to FIGS. 1 to 3, in the second time period 32, the lower first heater region 11 is controlled to be set in the warming state by the controller 100 (see the dotted first heater region in FIG. 1). Accordingly, the temperature stimulation (warm feeling) can be continuously applied to the occupant's buttocks 71 supported by the lower top plate main portion 40, which contributes to securing the warming property. The lower first heater region 11 is controlled to have a predetermined setting temperature, so that the occupant's buttocks 71 can be continuously warmed at an appropriate temperature as much as possible (see the first temperature change curve C1 in FIG. 3).

With reference to FIGS. 1 to 3, in the second time period 32, the lower second heater region 12 is controlled to be set in the non-warming state at a timing when the temperature reaches a predetermined temperature (a threshold value T2 described later). In this way, the lower second heater region 12 is brought into the non-warming state, and the amount of electricity supplied to the heater 8 in the lower second heater region 12 is reduced, which contributes to securing power saving (comfort will be described later). In the lower second heater region 12, the heater 8 is de-energized, so that the temperature gradually decreases over time (see a fifth temperature change curve C5 in FIG. 3). The upper second heater region 22 can also be in the low-temperature warming state in the second time period 32.

With reference to FIGS. 2 and 3, in the second time period 32, by performing the control described above, comfort for the occupant 70 can be more reliably secured as well as power saving property. That is, as described above, the occupant's thighs 72 warmed in the lower second heater region 12 are less required to be continuously warmed, and are sensitive to temperature and changes in temperature. Therefore, by appropriately controlling the lower second heater region 12 to prevent excessive temperature stimulation from being applied to the occupant's thighs 72, the occupant 70 is less likely to feel uncomfortable. Further, it is known that the magnitude of human temperature sensation is influenced by the multiplication of the magnitudes of temperature stimulation and physical stimulation. The occupant's thighs 72 receive both physical stimulation due to a seating reaction force from the seat cushion 4 (cushion pad or the like) and temperature stimulation. Therefore, even if the temperature stimulation from the lower second heater region 12 decreases, since physical stimulation such as the seating reaction force is continuously applied to the occupant's thighs 72, there is an illusion that the temperature sensation is continuing. In the heater control according to the present embodiment, the illusion phenomenon described above can be used by providing the second heater region in the front portion 40B of the lower top plate main portion 40. Accordingly, the comfort of the occupant 70 can be ensured by relatively simple control in which only the lower second heater region 12 is brought into the non-warming state or the like.

### Method for Setting Threshold Value

Here, in the second time period 32 illustrated in FIG. 3, as described above, the lower second heater region 12 can be controlled based on the predetermined temperature (threshold value T2). Methods for determining this type of threshold value T2 include related knowledge, a result of a thermal sensation report obtained by conducting a sensory test on a plurality of peoples, and output information from a human body thermal model. The human body thermal model is a mathematical model for calculating a body temperature distribution or the like of a human body by thermal absorption calculation between a virtual human model and a surrounding environment in consideration of a body temperature regulation reaction such as perspiration or blood flow. As this type of human body thermal model, a large number of models are known, such as the Stolwijk model (J. A. J. Stolwijk and J. D. Hardy, “Temperature Regulation in Man—A Theoretical Study” Pfluegers Archiv 291, pp 129 to 162, 1966) and the Wisseler model.

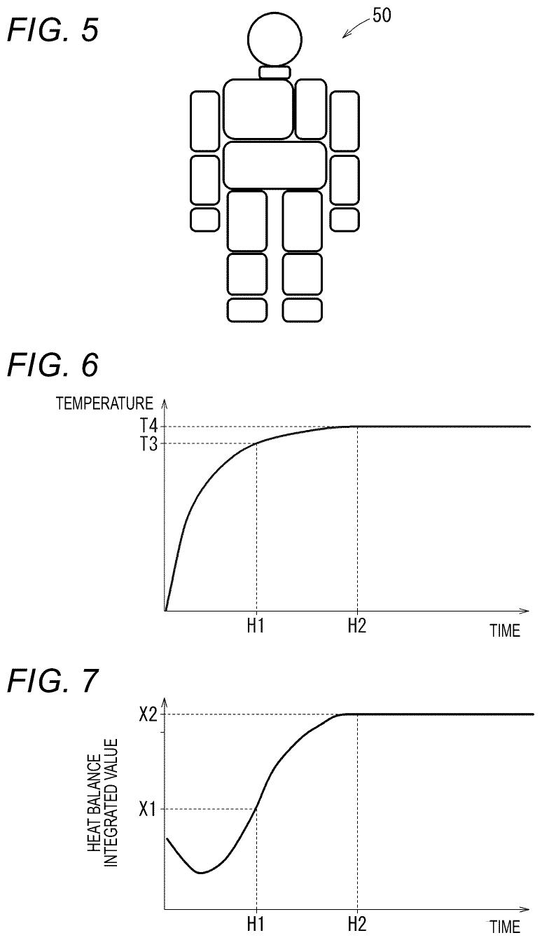

For example, in the seat cushion 4 illustrated in FIG. 2, the output information from the human body thermal model can be used as a reference when determining the threshold value. A human model 50 for a human body thermal model illustrated in FIG. 5 expresses its body composition by a skin layer and a core layer, and is divided into a plurality of portions (buttocks, thighs, waist, back, and the like). Then, various kinds of information (parameters) are measured with each heater region in the warming state, and then the information is input to the human model 50. Examples of this type of input information may include the temperature around the seated human body, and more specifically, the surface temperature of the seating surface illustrated in FIG. 6 and the temperature of the interior of the vehicle cabin adjacent to the human body. Other examples of input information include indoor environment information (humidity, wind speed, amount of radiant heat such as solar radiation, and the like) and human body information (amount of clothing worn, blood flow rate, metabolic rate, weight, body surface area, and the like).

According to the human body thermal model, a heat balance (for example, a change in an integrated heat balance over time) for each portion of the human body can be calculated by inputting various kinds of information. Therefore, in the present embodiment, the threshold value T2 for each heater region can be determined based on the integrated heat balance output from the human body thermal model. The threshold value T2 thus determined is calculated based on the quantitative environment information and the quantitative human body environment described above. Further, the threshold value T2 reflects various configurations of the vehicular seat 2, for example, a thermal conductivity of the cushion cover 4S or the lower internal member 5, a thermal conductivity of the back cover 6S or the upper internal member 7 (see FIGS. 1 to 3). Therefore, comfort for the occupant can be more reliably ensured by using the threshold value T2. With reference to FIGS. 3, 6, and 7, as a method for determining the threshold value T2 based on the integrated heat balance, for example, a heat balance integrated value X1 is set with reference to related knowledge or the like. Then, a time H1 required to reach the heat balance integrated value X1 is calculated, and a surface temperature of the seating surface at that time (candidate temperature T3) is set as the threshold value T2. As another method for determining the threshold value T2, a method is given in which a time H2 required to reach a heat balance integrated value X2 in a stable period is calculated, and a surface temperature of the seating surface at that time (another candidate temperature T4) is set as the threshold value T2. The candidate temperature T3 and the another candidate temperature T4 are usually higher than the transition temperature T1 described above. Further, the threshold value T2 can be set in any range between the transition temperature T1 and the candidate temperature T3, between the transition temperature T1 and the another candidate temperature T4, or between the candidate temperature T3 and the another candidate temperature T4. The controller 100 illustrated in FIG. 1 can receive a heat balance integrated value obtained in advance and information on each of the temperatures described above. If possible, the vehicular seat 2 (controller) may be provided with a function similar to that of the human body thermal model to output the integrated heat balance while measuring various types of information in real time.

### Third Heater Region

Further, with reference to FIG. 8, the seat cushion 4 may be provided with lower third heater regions 13. In the seat cushion 4, the lower top plate side portion 41 extends in the front-rear direction so as to straddle the front portion 40B and the rear portion 40A of the lower top plate main portion 40 (see dotted portions in FIG. 8). The lower top plate side portion 41 is a portion that is relatively less in contact with the occupant, and is a portion that is less required to be continuously warmed as compared with the rear portion 40A of the lower top plate main portion 40. Therefore, in the seat cushion 4, the lower third heater region 13 can be provided at a position of the lower top plate side portion 41, that is, a position of the seating surface different from the lower first heater region 11 and the lower second heater region 12 (in FIG. 8, for convenience, a reference numeral corresponding to the right lower third heater region is given, and a reference numeral corresponding to the left lower third heater region is given in parentheses). The power density of a heater of the lower third heater region 13 is not particularly limited, but can be set to be within, for example, the same range as that of the lower first heater region 11 (lower second heater region 12).

With reference to FIGS. 3 and 8, in the seat cushion 4, the lower third heater region 13 can be controlled to be set in the warming state in the first time period 31. Accordingly, by warming substantially the entire region of the seating surface of the seat cushion 4, the lower body of the occupant can be warmed over a wide range, which further contributes to ensuring the temperature rising property. Further, in the second time period 32, the lower third heater region 13 is controlled to be set in the non-warming state or the like, which contributes to securing power saving (see a fourth temperature change curve C4 in FIG. 3). At this time, by synchronizing the lower second heater region 12 and the lower third heater region 13, the control can be facilitated. Further, by independently controlling the lower second heater region 12 and the lower third heater region 13, the occupant can be finely warmed. The lower second heater region 12 and the lower third heater region 13 may be brought into the low-temperature warming state independently or in synchronization with each other.

As described above, in the seat cushion 4 according to the present embodiment, both the lower first heater region 11 and the lower second heater region 12 are controlled to be set in the warming state in the first time period 31. Accordingly, the temperature of the seating surface rises quickly, which contributes to ensuring the temperature rising property. Further, the lower first heater region 11 is controlled to be set in the warming state in the second time period 32. The lower first heater region 11 is provided in the rear portion 40A of the seat cushion 4. Accordingly, the lower first heater region 11 can continuously warm the target portion of the occupant 70, that is, the occupant's buttocks 71 at a suitable temperature as much as possible. During the second time period 32, the lower second heater region 12 is controlled to be set in the non-warming state or the low-temperature warming state, which contributes to securing power saving. Therefore, according to the present embodiment, both the warming property and the power saving property can be more reliably achieved.

Further, in the present embodiment, the lower first heater region 11 including the heater 8 having a desired power density allows the target portion of the occupant 70 to be continuously warmed at an appropriate temperature. In the present embodiment, the occupant 70 can be warmed over a wider range by the function of the lower first heater region 11, the lower second heater region 12, and the lower third heater region 13. By synchronizing the lower second heater region 12 and the lower third heater region 13, control is facilitated, and by controlling both the lower second heater region 12 and the lower third heater region 13 independently, the occupant 70 can be finely warmed. In the present embodiment, the lower third heater region 13 functions to warm the lower top plate side portions 41 of the seat cushion 4, thereby warming the occupant 70 from sides thereof.

### Heater Configuration of Seat Back

In the vehicular seat 2 illustrated in FIGS. 1 and 2, the upper top plate main portion 60 of the seat back 6 is divided into a lower portion 60A and an upper portion 60B. The lower portion 60A of the upper top plate main portion 60 is a portion that supports an occupant's waist 73, and the upper portion 60B of the upper top plate main portion 60 is a portion that supports an occupant's back 74 by being disposed upward relative to the lower portion 60A. Since the occupant's waist 73 is a portion that is brought into contact with the lower portion 60A of the upper top plate main portion 60 for a long period of time during seating, it is desirable to continuously warm the occupant's waist 73. Further, the occupant's back 74 is a portion in which a contact time with the upper portion 60B of the upper top plate main portion 60 is relatively short during seating, and a pressure applied to the upper top plate main portion 60 is also relatively low. Therefore, the occupant's back 74 is a portion that is less required to be continuously warmed as compared with the occupant's waist 73.

With reference to FIGS. 1 and 2, the seating surface of the seat back 6 is divided into heater regions in consideration of the seating pressure applied from the occupant 70. That is, in the seat back 6, the upper first heater region 21 is provided in the lower portion 60A of the upper top plate main portion 60, and the occupant's waist 73 can be warmed by the upper first heater region 21. A formation range of the upper first heater region 21 can be set around a portion to which the seating pressure is most applied in the lower portion 60A of the seat back 6 supporting the occupant's waist 73. In the seat back 6, the upper first heater region 21 is provided in substantially the entire region of the lower portion 60A of the upper top plate main portion 60 so as to more reliably cover the occupant's waist 73. The upper second heater region 22 is provided in the upper portion 60B of the upper top plate main portion 60, and the occupant's back 74 can be warmed by the upper second heater region 22. In the seat back 6, the lower second heater region 12 is provided in substantially the entire region of the upper portion 60B of the lower top plate main portion 40 so as to more reliably cover the occupant's back 74. Also in the seat back 6, as will be described later, each heater region can be individually controlled by the controller 100, that is, the heater control can be divided into at least two systems for control. A range of the power density of the heater 8 in the upper first heater region 21 can be set to be the same as that in the lower first heater region 11. The power density of the heater 8 in the upper second heater region 22 can also be set to be the same as that in the lower second heater region 12.

Also on the seating surface of the seat back 6 illustrated in FIG. 2, one or more temperature sensors 9 are provided in each of the lower portion 60A and the upper portion 60B of the upper top plate main portion 60 and the upper top plate side portions 61. When at least one of the heater regions is in the warming state, temperature information at each position of the seating surface is input to the controller 100.

### Heater Control on Seat Back Side

Also in the seat back 6 illustrated in FIGS. 1 and 2, each of the heater regions described above can be brought into the warming state for a predetermined period. Therefore, also in the heater control of the seat back 6, the warming period in each heater region is divided into the first time period 31 and the second time period 32 following the first time period 31 based on the temperature of the seating surface portion (see FIG. 3).

### Heater Control During First Time Period

With reference to FIGS. 2 to 4, in the heater control of the seat back 6, both the upper first heater region 21 and the upper second heater region 22 are controlled to be set in the warming state in the first time period 31. In this way, both the upper first heater region 21 and the upper second heater region 22 are brought into the warming state in the first time period 31, thereby warming substantially the entire region of the upper top plate main portion 60, and contributing to ensuring the temperature rising property. In addition, both the occupant's waist 73 and the occupant's back 74 are warmed by the upper first heater region 21 and the upper second heater region 22. Accordingly, when the occupant's back 74 comes into contact with the seat back 6, the occupant's back 74 can perceive warming at any timing.

### Heater Control During Second Time Period

With reference to FIGS. 1 to 3, in the second time period 32, the upper first heater region 21 is controlled to be set in the warming state by the controller 100. Accordingly, the temperature stimulation (warm feeling) can be continuously applied to the occupant's waist 73 supported by the upper top plate main portion 60, which contributes to securing the warming property. The upper first heater region 21 is controlled to have a predetermined setting temperature, so that the occupant's waist 73 can be continuously warmed at an appropriate temperature as much as possible (see the first temperature change curve C1 in FIG. 3). In the second time period 32, the upper second heater region 22 is controlled to be set in the non-warming state at a timing when the temperature reaches the predetermined temperature (threshold value T2). In this way, the upper second heater region 22 is brought into the non-warming state, and the amount of electricity supplied to the heater 8 in the upper second heater region 22 is reduced, which contributes to securing power saving. In the upper second heater region 22, the heater 8 is de-energized, so that the temperature gradually decreases over time (see the fifth temperature change curve C5 in FIG. 3). The upper second heater region 22 can also be in the low-temperature warming state in the second time period 32.

### Third Heater Region

Further, with reference to FIG. 8, the seat back 6 may be provided with upper third heater regions 23. In the seat back 6, the upper top plate side portion 61 extends in the up-down direction so as to straddle the lower portion 60A and the upper portion 60B of the upper top plate main portion 60. The upper top plate side portion 61 is a portion that is relatively less in contact with the occupant 70, and is a portion that is less required to be continuously warmed as compared with the lower portion 60A of the upper top plate main portion 60. Therefore, in the seat back 6, the upper third heater region 23 can be provided at a position of the upper top plate side portion 61, that is, a position of the seating surface different from the upper first heater region 21 and the upper second heater region 22. The power density of the heater of the upper third heater region 23 is not particularly limited, but can be set to be within, for example, the same range as that of the upper first heater region 21 (upper second heater region 22).

With reference to FIGS. 3 and 8, also in the seat back 6, the upper third heater region 23 can be controlled to be set in the warming state in the first time period 31. Accordingly, by warming substantially the entire region of the seating surface of the seat back 6, the upper body of the occupant can be warmed over a wide range, which further contributes to ensuring the temperature rising property. Further, in the second time period 32, the upper third heater region 23 is controlled to be set in the non-warming state, which further contributes to securing power saving (see the fourth temperature change curve C4 in FIG. 3). At this time, by synchronizing the upper second heater region 22 and the upper third heater region 23, the control can be facilitated. Further, by independently controlling the upper second heater region 22 and the upper third heater region 23, the occupant 70 can be finely warmed. The upper second heater region 22 and the upper third heater region 23 may be brought into the low-temperature warming state independently or in synchronization with each other.

As described above, also in the seat back 6 according to the present embodiment, both the upper first heater region 21 and the upper second heater region 22 are controlled to be set in the warming state in the first time period 31. Accordingly, the temperature of the seating surface rises quickly, which contributes to ensuring the temperature rising property. Further, the upper first heater region 21 is controlled to be set in the warming state in the second time period 32. The upper first heater region 21 is provided in the lower portion 60A of the seat back 6. Accordingly, the upper first heater region 21 can continuously warm the target portion of the occupant 70, that is, the occupant's waist 73 at a suitable temperature as much as possible. During the second time period 32, the upper second heater region 22 (upper third heater region 23) is controlled to be set in the non-warming state or the low-temperature warming state, which contributes to securing power saving. Therefore, according to the present embodiment, both the warming property and the power saving property can be more reliably achieved.

The heater control method for a vehicular seat of the present embodiment is not limited to the embodiment described above, and various other embodiments are possible. For example, in the present embodiment, an example has been described in which each of the seat cushion and the seat back is provided with heater regions. Each heater region can be provided in at least one of the seat cushion or the seat back, and the third heater region can be omitted as appropriate. The third heater region can be provided in a part or all of the corresponding top plate side portion, and can also be provided in a front end of the lower top plate main portion close to occupant's knees or an upper end portion of the upper top plate main portion close to an occupant's neck. In each heater region, a plurality of heaters can be disposed adjacent or close to each other, and a single heater can be disposed. The heater control method can also be changed as appropriate, and the control on the seat cushion side and the control on the seat back side may be different. For example, in the seat cushion, the lower second heater region and the lower third heater region can be controlled in synchronization, and in the seat back, the upper second heater region and the upper third heater region can be controlled independently, and vice versa. The setting temperature and the threshold value can be independently set for each heater region, and a common setting temperature and threshold value can be set for all the heater regions. The heater control of the controller may be wired or wireless, and a controller (ECU or the like) of the vehicle or a controller dedicated to the heater can be used as the controller. The configuration of the present embodiment can be applied to general vehicular seats, such as seats for cars, airplanes, trains, and ships. Although there is not limited in particular, the controller can be implemented by one or more processors, and the processor may include a volatile memory, and a nonvolatile memory. For example, the processor may be configured to execute the heater control method for the vehicular seat as a heater control system in accordance with a program stored in the nonvolatile memory.

What is claimed is:

1. A heater control method for a vehicular seat, a seating surface of the vehicular seat being provided with a first heater region and a second heater region in a divided state as a region including a heater, wherein
a warming period by the heater is divided into a first time period including start of warming and a second time period following the first time period,
the first heater region is controlled to be continuously set in a warming state between the first time period and the second time period,
the second heater region is controlled to be set in the warming state in the first time period and to be set, during the second time period, in a low-temperature warming state having a lower temperature than the warming state in the first time period or in a non-warming state,
the first heater region and the second heater region are provided in at least one position of the following positions 1 and 2, and
in the position 1, a seating surface of a seat cushion to be a seat portion includes a lower top plate main portion extending in a front-rear direction at a center in a seat width direction, the first heater region is provided in a rear portion of the lower top plate main portion configured to support occupant's buttocks, and the second heater region is provided in a front portion of the lower top plate main portion with respect to the first heater region, and
in the position 2, a seating surface of a seat back to be a backrest includes an upper top plate main portion extending in an up-down direction at the center in the seat width direction, the first heater region is provided in a lower portion of the upper top plate main portion configured to support an occupant's waist, and the second heater region is provided in an upper portion of the upper top plate main portion with respect to the first heater region.

2. The heater control method for the vehicular seat according to claim 1, wherein
a third heater region including a heater is provided in a position of a seating surface different from the first heater region and the second heater region, and
the third heater region is controlled to be set in the warming state in the first time period and to be set, during the second time period, in the low-temperature warming state or the non-warming state in synchronization with or independently of the second heater region.

3. The heater control method for the vehicular seat according to claim 2, wherein
the first heater region, the second heater region, and the third heater region are provided in at least one position of the following positions 1 and 2, and
in the position 1, the first heater region is provided in the rear portion of the lower top plate main portion, the second heater region is provided in the front portion of the lower top plate main portion with respect to the first heater region, and the third heater region is provided in a side portion in the seat width direction of the lower top plate main portion, and
in the position 2, the first heater region is provided in the lower portion of the upper top plate main portion, the second heater region is provided in the upper portion of the upper top plate main portion with respect to the first heater region, and the third heater region is provided in a side portion in the seat width direction of the upper top plate main portion.

4. A heater control system for the vehicular seat according to claim 1, comprising:
a controller; and
a memory storing a program causing the controller to execute the heater control method, wherein
the controller executes control of the heater to:
continuously set the first heater region in the warming state between the first time period and the second time period; and
set the second heater region in the warming state in the first time period and set, during the second time period, in the low-temperature warming state having the lower temperature than the warming state in the first time period or in the non-warming state.
